(19) United States
(12) Patent Application Publication
(10) Pub. No.: US 2026/0358051 A1
(43) Pub. Date: Nov. 12, 2026

(54) METHODS AND SYSTEMS OF CONTROLLING A DRYING OPERATION

(71) Applicant: WESTMILL INDUSTRIES LTD., Abbotsford (CA)

(72) Inventor: Michael CRONDAHL, Abbotsford (CA)

(21) Appl. No.: 19/671,903

(22) Filed: May 8, 2026

Related U.S. Application Data
(60) Provisional application No. 63/802,729, filed on May 9, 2025.

(51) Int. Cl. F26B 21/33

(52) U.S. Cl. CPC F26B 21/33

(57) ABSTRACT

Methods and systems for controlling a drying operation are disclosed. The dryer controller system is integrated for use with a suitable dryer. In some embodiments, the method comprises determining a wet mass data of a load of the material upstream of the dryer. The controller is configured to determine an excess moisture content of the load using the determined wet mass data and a stored species-specific dry density, and a predicted amount of energy required to dry the load based on the determined excess moisture content. Based on the predicted amount of energy, the controller determines at least one operational parameter for the dryer, and transmits an output signal comprising the at least one operational parameter to one or more control units of the dryer.

### FIELD OF THE INVENTION

The present invention relates to methods and systems of controlling a drying operation, in particular, those which control the drying of wood products such as veneer.

### BACKGROUND

Single and multiple deck conveyor dryers for reducing the moisture content of sheet materials (including green (i.e. wet) wood veneer) and composite materials, wherein the material being dried is conveyed through a stationary drying chamber while heated gases are circulated through the drying chamber, are known in the art. Drying conditions and conveying speeds are typically optimized to produce a high yield of satisfactorily dried veneer and limit the amount of veneer that is “overdry”. In limiting the amount of veneer that is overdry, some veneer exiting the dryer will have a moisture content that makes it unsuitable for immediate use in wood composite products, such as plywood. This is because excess moisture in the veneer will cause layers in the composite product to delaminate. Veneer exiting the dryer with excess moisture content is often referred to as “redry”.

There is a general desire to produce high quality wood products and/or reduce one or more of wood product losses, energy losses, the amount of redry, and the costs associated with wood product treatment (e.g. veneer drying, wood composite product production, etc.). There is a general desire to reduce waste during wood product and veneer production, for example by precision drying. There is a general desire to improve the energy efficiency, costs, and performance of wood product drying systems including veneer drying systems.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Some aspects of the invention pertain to a dryer controller system. The dryer controller system described herein is communicatively coupled to a dryer. Integrating the dryer controller system described herein to the dryer results in a particularly energy efficient and precise drying of materials, achieving a dried load with the desired or optimal moisture content after transporting the wet materials through the dryer once, i.e., allowing the wet materials to be “dried right first time”. One non-limiting example of application of the dryer controller system is in the field of wood veneer drying; however, the dryer controller system may be adapted for use in other fields for drying other suitable materials.

In some embodiments, the dryer controller system comprises a sensor configured to obtain a wet mass data corresponding to a load of a material to be dried. The wet mass data may be acquired either by direct measurement (e.g., which may involve a scale at weighing station) or indirectly by computation (e.g., based on load metadata). The sensor is communicatively coupled to a controller. The controller may in turn be communicatively coupled to one or more unit controls of the dryer. The one or more unit controls are configured to adjust or otherwise control the one or more operational means in the dryer. In some embodiments, the sensor comprises a weight sensor. The weight sensor is configured to measure a weight of the material.

In some embodiments, the dryer controller system further comprises a process moisture sensor mounted in a dryer exhaust of the dryer. The process moisture sensor may be configured to obtain information pertaining to an amount of moisture removed from the dryer through a dryer exhaust while the material is being dried. Such moisture content may be indicative of the amount of moisture that has already been removed from the material that is being dried. Such information may be transmitted from the process moisture sensor to the controller. The controller may be configured to transmit an output signal comprising one or more operational parameters to the respective control unit for controlling (and thereby adjusting if necessary) the operation of the respective operational means while the materials are still being transported or dried through the dryer. In some example embodiments, the process moisture sensor comprises an absolute-humidity sensor.

The dryer controller system is arranged upstream of the dryer, positioned to obtain a wet mass data of the material to be dried. The wet mass is used by the controller to predict one or more operational parameters of the drying operation, in order to achieve a dried load with a desired or optimal moisture content.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the basic components of a drying system according to an example embodiment of the invention.

FIG. 2 is another schematic diagram illustrating the components of the FIG. 1 drying system.

FIG. 3 is a flow chart illustrating the steps of a method for controlling a drying operation according to an example embodiment.

### DESCRIPTION

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

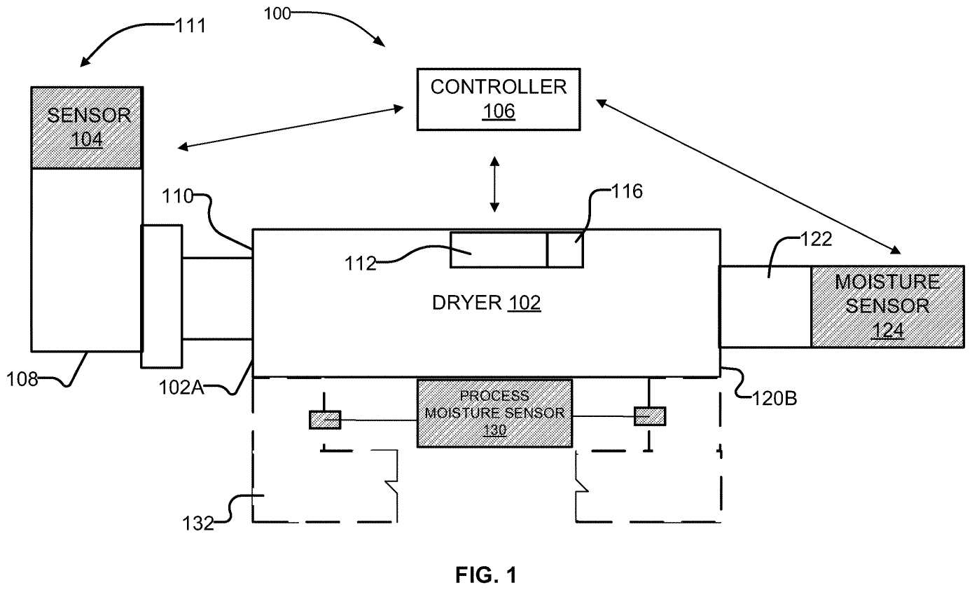

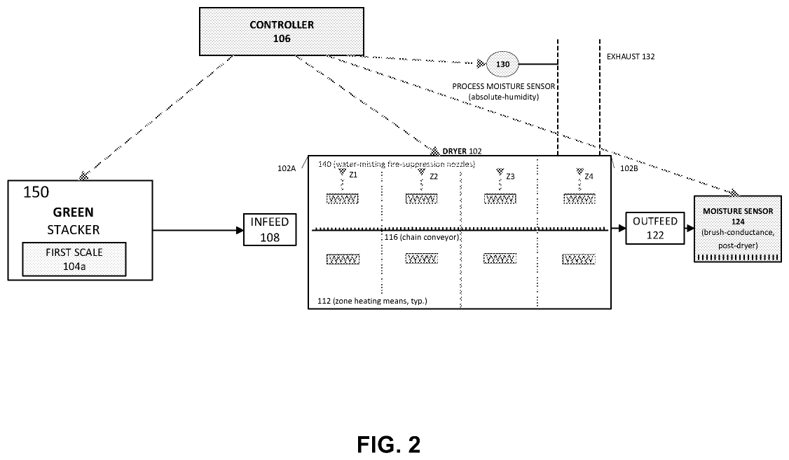

Some aspects of the invention pertain to a system 100 for controlling a drying operation. Referring to FIGS. 1 and 2, the dryer controller system 100 is communicatively coupled to a dryer 102. The dryer 102 is configured to reduce the moisture content of a material to be dried. A “dryer” may comprise any suitable apparatus configured to reduce the moisture content of a material to be dried, including but is not limited to a conveyor-type dryer or oven, e.g., wood veneer dryer, a press dryer, a radio-frequency (RF) dryer, a vacuum dryer, etc. The dryer controller system 100 is configured to control one or more operational parameters of the dryer 102.

In some embodiments, the dryer controller system 100 comprises a sensor 104 and a controller 106 communicatively coupled to the sensor 104. The sensor 104 may be arranged at a weighing station 111. The weighing station 111 may be arranged upstream of the input end 102A of the dryer 102. The weighing station 111 may for example be located at a green-stacker station 150 (e.g., a station where wet wood veneer is handled or stacked into the loads that are processed by a dryer), and/or any other suitable location where a load of the materials to be dried can be weighed before entering the dryer 102.

The controller 106 may be centralized (e.g., an individual entity) or distributed (e.g., a cluster of controllers which may be programmed and configured to perform different functions and to feed information back to a supervisory controller).

In some embodiments, the sensor 104 is configured to determine a mass of a load of the material to be dried (e.g., wet veneer) to obtain wet mass data. For example, in the field of veneer drying, the veneer may be arranged in loads to be weighed and dried together.

The wet mass data may be acquired by direct measurement or indirectly by computation. In some embodiments, the sensor 104 is a scale. In some embodiments, the sensor 104 is configured to directly measure the wet mass of the load before entering the dryer 102. The sensor 104 may be configured to transmit a signal comprising the measured wet mass data to the controller 106.

In some embodiments, the controller 106 is configured to receive load metadata, for example from an external source (e.g., a user input and/or a green-stacker control system). This load metadata may for example include the material's species (e.g., the type of veneer), nominal thickness, sort type (e.g., “Light SAP”, “Heavy SAP”, “Heart”, etc.), and a sheet count for the load. The controller 106 may be configured to calculate an inferred wet mass for the load of the materials to be dried using this load metadata, along with a stored mass-per-sheet lookup table.

In some embodiments, an infeed conveyor system 108 is arranged upstream of the input end 102A of the dryer 102. The infeed conveyor system 108 may be configured to convey the incoming load of the materials to be dried into a drying chamber 110 of the dryer 102.

The sensor 104 need not be arranged at the infeed conveyor system 108, or near the input end 102A of the dryer 102. The sensor 104 may be arranged at any other location that is suitable for the load to be dried to contact with prior to being supplied to the dryer 102. One such other location may for example be at a green-stacker station positioned upstream of the veneer handling line.

The controller 106 is programmed to determine an excess moisture content of the incoming load of the material based on the wet mass data. Based on the determined excess moisture content, the controller 106 may be programmed to determine a predicted amount of energy required to dry the material to a desired moisture level. Based on the predicted amount of energy, the controller 106 may be configured to determine one or more operational parameters for drying the load to the desired moisture level.

In some embodiments, the excess moisture content of the material is calculated based on a stored known dry density information of the load to be dried. Such known dry density information may be stored in memory in the database of the controller.

For example, in embodiments in which the material to be dried is veneer, the database of the controller 106 may include known dry density information of veneer. The dry density is an intrinsic material property of a species (which refers to the type of wood being processed). The dry density is expressed as a mass of oven-dry wood per unit volume. The dry density is distinct from the desired final moisture content, which the latter is a process target. Moisture content may be reported on either a dry basis (i.e., mass of water divided by oven-dry mass of wood) or a wet basis (i.e., mass of water divided by total mass of wet wood). Except where otherwise specified, moisture content values herein refer to a dry basis. Green veneer moisture content, reported on a dry basis, may range from about 30% to about 250% depending on species and origin.

The known dry density information may include a range of values, such as for example 500 to 900 kg/m³. The known dry density may be stored in the database of the controller 106 as a species-specific lookup table. For example, Douglas-fir has an oven-dry density of approximately 450-500 kg/m³, southern yellow pine of approximately 500-600 kg/m³, hard maple of approximately 630-700 kg/m³, and certain tropical hardwoods may exceed 900 kg/m³. The controller may be configured to select the dry-density value for a given load using a species identifier and, optionally, a sort-type identifier (such as “Light SAP”, “Heavy SAP”, or “Heart”, etc.) associated with the load.

The excess moisture content of the material may be determined by calculating a target mass of water that needs to be evaporated from the wet load to reach a desired final moisture content.

In some embodiments, the controller 106 is configured to determine the theoretical mass of the load if it were completely free of water (i.e., moisture content of 0%). In some example embodiments, the calculation of the theoretical mass of the load with 0% moisture content or oven-dry mass (m_oven_dry) may comprise multiplying the known physical volume of the load (V_load) by the stored dry density for the specific wood species (ρ_dry):

m_oven_dry=ρ_dry×V_load.

The controller 106 may then be configured to calculate the target mass of the dried load (m_dry_target). In some example embodiments, the target mass (m_dry_target) is calculated by multiplying the oven-dry mass (m_oven_dry) by a factor of (1+MC_target), where MC_target represents the desired final moisture content expressed on a dry basis:

m_dry_target=m_oven_dry×(1+MC_target).

The controller 106 may then be configured to calculate the total mass of water to be removed (m_water). The total mass of water to be removed (m_water) may be calculated by subtracting the target mass (m_dry_target) from the initial measured wet mass (m_wet):

m_water=m_wet−m_dry_target.

The total mass of water to be removed, m_water, is the predicted amount of moisture to be evaporated from the load.

The controller 106 is programmed to determine, based on the determined excess moisture content, a predicted amount of energy required to dry the material to a desired moisture level.

In some embodiments, the predicted amount of energy is determined from an enthalpy balance across the dryer 102, i.e., the energy difference between the air entering the dryer and the air exiting it. In some example embodiments, the controller 106 is programmed and configured to compute a specific enthalpy (h) of the air at both the input end and the output end of the dryer. For example, by using the formula:

h=C_p·T+ω·(L_0+C_v·T),

wherein C_p is a specific heat of dry air, T is a gas temperature, ω is a humidity ratio, L_0 is a reference latent heat of vaporization of water (for example approximately 2500 kJ/kg), and C_v is a vapour correction coefficient. The controller may then be configured to calculate the enthalpy rise (Enthalpy Rise=h_outlet−h_inlet) across the dryer, which is the difference between the outlet and inlet specific enthalpies. The controller 106 may then be configured to calculate the total energy required to achieve the required evaporation by multiplying the enthalpy rise (Enthalpy Rise) by the total mass flow rate of the drying gas moving through the dryer 102.

In some embodiments, the enthalpy balance calculation is supplemented or replaced by a plant-calibrated lookup table and/or a trained machine-learning model. The controller 106 may be programmed with such plant-calibrated lookup table and/or trained machine-learning model. For example, a plant-calibrated lookup table may map wet mass and other load data directly to a required energy value. A trained machine-learning model may be used to predict the energy based on past operational data. These models are periodically updated using new data collected by the controller 106.

The controller 106 need not be programmed to determine an excess moisture content of the incoming material, and/or to determine a predicted amount of energy required to dry the material to a desired moisture level, and based on the predicted amount of energy, determine one or more operational parameters for drying the material to the desired moisture level. In some embodiments, an operator manually determines the excess moisture content of the incoming material based on the information (e.g., mass) of the material to be dried and/or determine the one or more operational parameters for drying the material to the desired moisture level. The operator may manually input one or more operational parameters into the controller for controlling a drying operation.

The controller 106 may be programmed to determine, based on the predicted amount of energy, one or more operational parameters for drying the material to the desired moisture level.

The dryer 102 comprises one or more control units 112. The one or more control units 112 are operatively connected to one or more operational means provided in the dryer 102. For example, the dryer 102 comprises a motor control unit 112. The motor control unit 112 is operatively connected to one or more conveying means 116 configured to control an operation of such conveying means (e.g., activation, deactivation, and/or speed, etc.). The dryer 102 may additionally comprise a temperature control unit. The temperature control unit may be operatively connected to one or more heating means and/or cooling means configured to control an operation of such means (e.g., activation, deactivation, etc.).

In some embodiments, the drying chamber 110 is divided into a plurality of longitudinal zones. Each zone may have an independently controllable heating means and/or an independently controllable exhaust. The temperature control unit may be configured to receive a zone-specific temperature setpoint and/or a zone-specific airflow setpoint from the controller 106, and to apply the setpoints to the corresponding longitudinal zone. These setpoints may be assigned based on wet mass data for the load and/or a stored drying trajectory for the species associated with the load.

The dryer 102 may additionally comprise an airflow control unit. The airflow control unit may be operatively connected to a circulation fan configured to control an operation of the circulation fan (e.g., activation, deactivation, rotational speed, etc.). The dryer 102 may further additionally comprise an exhaust control unit. The exhaust control unit may be operatively connected to exhaust valve configured to control an operation of the exhaust valve (e.g., opening, closing, etc.).

The dryer 102 may additionally comprise a fire suppression unit arranged in the drying chamber 110. The fire suppression unit (e.g., a water-misting system) may be operatively connected to the controller 106. The controller 106 may be communicatively coupled to one or more fire-detection inputs. The one or more fire-detection inputs may for example comprise one or more exhaust carbon monoxide sensor, an exhaust temperature sensor, a thermal imaging sensor, and a volatile organic compound sensor. Upon detection of a fire condition or a pre-fire condition from the one or more fire-detection inputs, the controller 106 may be configured to activate, as a first automatic control action, the fire suppression unit. The controller 106 may be configured to additionally perform one or more secondary automatic control actions. Such secondary automatic control actions may for example be one or more of a zone temperature setpoint, adjusting an exhaust airflow setpoint, reducing the conveyor speed, stopping the conveyor, signaling an upstream conveyor to stop feeding additional loads into the dryer 102, etc.

The controller 106 may be configured to transmit an output signal comprising the one or more operational parameters to the respective control unit 112. The respective control unit 112 may be configured to control the operation of the respective operational means such as the conveying means, the heating means and/or cooling means, etc.

In some embodiments, the dryer 102 comprises one or more process moisture sensors 130 mounted therein. In some embodiments, the one or more process moisture sensors 130 are mounted in a dryer exhaust 132. The one or more process moisture sensors 130 may be communicatively coupled to the controller 106.

The one or more process moisture sensors 130 may be configured to measure an amount of moisture (e.g., the mass of water) that has been removed from the dryer 102 through the dryer exhaust 132. Such moisture content may be indicative of the amount of moisture that has already been removed from the material being dried in the dryer 102. In some example embodiments, the one or more process moisture sensors 130 comprises an absolute-humidity sensor. In some embodiments, the absolute-humidity sensor is configured to measure a mass concentration of water vapour in the dryer exhaust (for example, in grams per cubic meter). The controller 106 may be configured to determine a total mass of water removed from a specific load based on the measured mass concentration of water vapour. For example, the controller 106 may be configured to determine the rate of water removal by multiplying the calculated mass concentration of water vapour by the measured volumetric flow rate of the dryer exhaust to obtain a mass rate of water removal. The controller 106 may be configured to accumulate the mass rate of water removal over the residence time of the load in the dryer to obtain the total mass of water removed for a particular load.

Such moisture content may be transmitted to the controller 106. The controller 106 may be configured to transmit an output signal comprising the one or more operational parameters to the respective control unit 112 for controlling the operation of the respective operational means while the materials are still being transported through the dryer 102. Such controlling may for example comprise adjusting the operation of the respective operational means such as the conveying means for adjusting the conveying speed at which the materials are being transported through the dryer 102, and/or the heating means and/or cooling means for adjusting the temperature that is being maintained within the dryer 102, etc. The arrangement of the process moisture sensors 130 in the dryer exhaust 132 allows for adjustment of one or more operational parameters of the dryer 102 while the material is still being transported through the dryer 102, i.e., the material still has remaining drying time in the dryer 102.

In some embodiments, an outfeed conveyor system 122 is arranged downstream of the output end 102B of the dryer 102. The outfeed conveyer system 122 is configured to transport the dried load away from the output end 102B of the dryer 102. In some embodiments, a moisture sensor 124 is arranged at the outfeed conveyor system 122. The moisture sensor 124 is configured to measure a moisture content of the dried load. The moisture sensor 124 may be communicatively coupled to the controller 106. The moisture sensor 124 may be configured to transmit an output signal comprising the moisture content of the dried load to the controller 106. The controller 106 may be programmed to evaluate, based on the moisture content of the dried load, the performance of the drying operation.

One non-limiting example of a suitable moisture sensor 124 is a brush-conductance-type dry-chain moisture meter. Such a brush-conductance-type moisture meter may for example comprise a plurality of wire-brush electrodes arranged to contact a surface of the dried load and configured to measure an alternating current flow between adjacent brushes. The measured current flow is indicative of the material's moisture level. The measured current flow may be a raw current measurement. Such a raw current measurement may be processed for example by compensating for variations in material temperature and/or thickness. The compensated values may be converted into a sheet-level moisture content (i.e., the specific moisture value calculated for an individual sheet of the load of the materials (e.g., a single piece of veneer)). The dried load may be classified into one of several predefined moisture bands (for example, overdry, dry, level 1, level 2, level 3, and overwet, etc.). The sheet-level moisture content and/or the classification may be transmitted to the controller 106.

The moisture sensor 124 need not be arranged at the outfeed conveyor system 122. The moisture sensor 124 may be arranged at any other location that is suitable for the dried load to come in contact with after output from the dryer 102.

In some embodiments, the controller 106 is programmed to collect such post processing moisture content information. Such post processing moisture content information may be correlated with the one or more operational parameters used in the drying operation. Such information may be applied in the determining of the one or more operational parameters for drying the material to the desired moisture level at the input end in subsequent drying operations.

In some embodiments, the controller 106 is configured and programmed to perform a closed-loop reconciliation for each load to continuously learn and improve its predictive accuracy. Such a closed-loop reconciliation may for example compare: (a) the predicted amount of water to be evaporated as determined from the wet mass data and the stored dry density (i.e., the feedforward prediction of water to be evaporated), (b) the measured mass of water removed thermally as determined from the in-process exhaust sensor, and (c) the final moisture classification reported by the downstream moisture sensor. The controller 106 may be programmed and configured to analyze discrepancies between these predicted and measured values to automatically update and refine its internal models (e.g., the stored dry-density lookup, enthalpy-balance coefficients, or a trained machine-learning model, etc.) for subsequent drying operations. The controller 106 may be configured and programmed to manage predictive uncertainty by applying a safety margin, requesting more sensor data, and/or flagging a load for manual review when the uncertainty of a prediction exceeds a stored threshold.

In some embodiments, the controller 106 is configured to receive the sensed mass of the material to be dried, and to predict, using a machine learning system, one or more operational parameters for drying the incoming material to the desired moisture content. The machine-learning system may be initially trained by training data to generate a machine-learning model that is capable of taking sensed wet mass inputs to produce an assessment (e.g., one or more operational parameters). Suitable training data may for example comprise data sets which include initial load characteristics (e.g., the load's wet mass, species identifier, nominal thickness, sort-type identifier, and sheet count, dryer operational parameters (e.g., conveyor speed, zone temperatures used during the drying operation), in-process measurements (e.g., the total mass of water removed thermally, as measured by the humidity sensor 124), and final outcome (e.g., the sheet-level moisture-band classification counts as reported by the downstream moisture sensor 124). The machine-learning model, which may be a regression or neural-network model, may be trained to minimize a loss function to improve the model's predictive accuracy over time. The loss function may for example be computed from the residual between the model's predicted final moisture content and the actual moisture band classification reported by the moisture sensor 124. The machine-learning system may be continually updated by training the system with additional training data.

The described dryer controller system may be adapted for use in continuous drying operations. In such embodiments, the dryer controller system 100 and the dryer 102 are adapted to receive a continuous supply of incoming materials to be dried, such as a supply of incoming wet veneer loads, for drying. A “continuous supply of incoming materials” means that the materials to be dried are supplied to the system sequentially. The materials may be dried without needing to stop the operation of the system. In such embodiments, the moisture contents of each of the plurality of materials in the continuous supply of incoming material may be different. The sensor 104 is in such embodiments adapted to continuously or periodically, transmit the sensed wet mass data to the controller 106 in real-time as the continuous supply of incoming loads of materials are being arranged to contact the sensor 104. In response, the controller 106 may, based on the received new wet mass data (e.g., if the wet mass data is different from the previously received wet mass data), transmit an output signal to the one or more control units 112 to adjust the operational parameters of the dryer 102 in order to achieve the desired drying result. As new incoming loads of materials are being fed into the dryer 102, the dryer control system 100 may be configured and programmed to gradually make adjustments to the operational parameters of the dryer 102 based on the new wet mass data. The dryer 102 may contain a plurality of loads at a time. In such embodiments, the loads may be placed in the dryer 102 at different times, and thus each load may have a different in-dryer history. In some embodiments, the controller 106 is configured to apply setpoint changes to account for the load which is already being dried. Such setpoint changes may for example be: (i) predicting the remaining residence time for each load currently in the dryer, (ii) gradually ramping setpoint changes over a calculated time interval to avoid disturbing loads near the output end 102B, and/or (iii) in embodiments in which the drying chamber is separated into different zones, applying zone-specific setpoint changes so that only the dryer zones ahead of a newly-admitted load are affected by the new operational parameters.

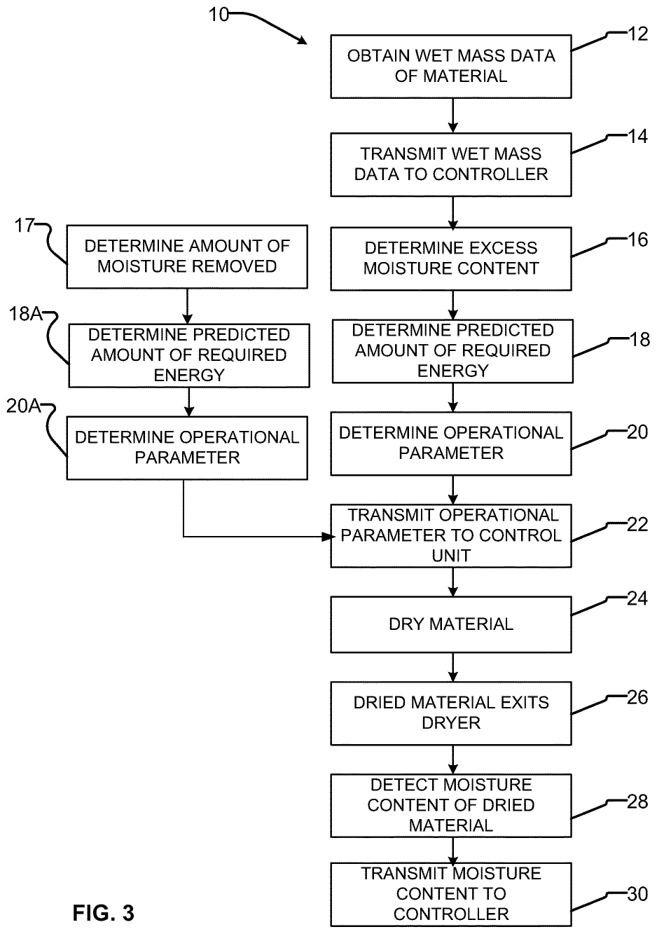

Some aspects of the invention pertain to a method of controlling a drying operation. FIG. 3 is a flow chart illustrating the steps of the method according to an example embodiment of the invention. The method may be performed using the dryer controller system 100.

Referring to FIG. 3, a method of controlling a drying operation 10 comprises obtaining a wet mass data of an incoming load of materials to be dried (block 12). The wet mass data may be obtained by directly measuring the mass of the load at an upstream weighing station or by computing an inferred wet mass from load metadata such as species, thickness, and sheet count, etc. In block 14, a signal comprising the wet mass data may be transmitted to the controller.

The controller may be programmed to determine, based on the wet mass data, an excess moisture content of the incoming material (block 16). In some example embodiments, this determination involves a mass balance calculation that uses stored species-specific dry density values to calculate the theoretical oven-dry mass of the load and, from that, the target mass of water to be evaporated to reach a desired final moisture content.

The controller may additionally be programmed to determine, based on the determined excess moisture content, a predicted amount of energy required to dry the load to a desired moisture level (block 18). This prediction may be calculated using an enthalpy balance across the dryer or, alternatively, by using a data-driven approach such as a plant-calibrated lookup table or a trained machine-learning model that maps the load characteristics directly to a required energy value.

The controller may be programmed to determine, based on the predicted amount of energy, one or more operational parameters for drying the load to the desired moisture level (block 20). The one or more operational parameters may comprise a conveyor speed of the dryer, a temperature that is maintained inside the drying chamber, a speed of a circulation fan that is arranged in the drying chamber and/or an amount of airflow circulated within the drying chamber, an exhaust flow out of the drying chamber, etc.

A signal comprising the one or more operational parameters may be transmitted from the controller to one or more control units of the dryer (block 22). The material is then dried (block 24) in accordance with the transmitted one or more operational parameters, and the dried load subsequently exits the dryer (block 26).

In some embodiments, the method comprises an in-process feedback loop. During the drying step, the method may comprise determining the amount of moisture that has already been removed from the material (block 17), for example by using a process moisture sensor, such as an absolute-humidity sensor mounted in the dryer exhaust. The process moisture sensor may be configured to obtain a real-time measurement of water removal. Based on this in-process data, the controller can re-determine a predicted amount of required energy (block 18A) and the operational parameters (block 20A) needed to complete the drying. This allows for dynamic adjustments to be made while the load is still being transported through the dryer.

In some embodiments, the method may also include a post-drying feedback loop. After the load exits the dryer, the method may comprise detecting the final moisture content of the dried load using a downstream moisture sensor, such as a brush-conductance-type meter (block 28). This final moisture content information may be transmitted to the controller (block 30). The controller may use this feedback to evaluate the performance of the drying operation. This feedback may be used as input for a closed-loop reconciliation process which compares the initial predictions with the in-process measurements and the final results, using any discrepancies to update and refine the internal models for improved accuracy in subsequent drying operations.

In some embodiments, an operator manually determines a predicted amount of energy required to dry the material to a desired moisture level based on the wet mass data obtained in block 12. In some embodiments, the operator inputs such predicted amount of energy into the controller, and the controller is programmed to determine the one or more operational parameters for drying the load to the desired moisture level. In some embodiments, the operator determines the one or more operational parameters for drying the load to the desired moisture level based on such predicted amount of energy. The operator may input the determined one or more operational parameters into the controller so as to control a drying operation. In some embodiments, the steps described in one or more of blocks 14, 18 and/or 20 may be omitted.

One non-limiting example application of the described systems and methods is in wood veneer drying. In some example methods of drying wood veneer using the described system, the incoming wet veneer may be arranged as a load at a weighing station upstream of the dryer. The load may be associated with load metadata (e.g., a species identifier, nominal thickness, sort-type identifier, sheet count, etc.). In some embodiments, the sensor is configured to obtain a wet mass data of the load, and to transmit a signal comprising such information to a controller. In some embodiments, the controller is configured to compute an inferred wet mass from the load metadata. The controller may then be configured to determine an excess moisture content level of the incoming load and/or the amount of energy required for drying the load to a predetermined desired moisture content (e.g., less than about 10% by weight, on a dry basis). The controller 106 may be configured to transmit an output signal comprising one or more predicted desired operational parameters to a motor controller. The motor controller is configured to adjust or otherwise control the speed at which the conveying means is moved along a longitudinal axis of the drying chamber, thereby controlling the speed at which the load is being transported along the drying chamber from the input to the output end, and correspondingly, the residence time of the load in the drying chamber. The load is dried in accordance with the predicted one or more operational parameters as determined by its wet mass before drying. As each load exits the dryer, a moisture sensor such as a brush-conductance-type dry-chain moisture meter which is arranged at or downstream of the output end may be configured to determine and transmit per-sheet moisture band classifications to the controller. In some embodiments, the controller is configured to perform a closed-loop reconciliation to update the stored dry-density lookup and/or the trained machine-learning model.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for controlling the drying of a load of material in a dryer, the method comprising:
(a) determining, at a location upstream of the dryer, a wet mass data of a load of the material;
(b) determining, by a controller, an excess moisture content of the load by performing a mass balance calculation based on the determined wet mass data and a stored species-specific dry density;
(c) determining, based on the determined excess moisture content, a predicted amount of energy required to dry the load;
(d) determining, based on the predicted amount of energy, at least one operational parameter for the dryer; and
(e) transmitting an output signal comprising the at least one operational parameter to one or more control units of the dryer; and
(f) drying the load of material in the dryer, wherein the dryer is operated in accordance with the at least one operational parameter to reduce a moisture content of the load.

2. The method as defined in claim 1, wherein the determining of the wet mass data in step (a) comprises measuring a mass of the load at a sensor arranged upstream of an input end of the dryer.

3. The method as defined in claim 1, wherein the determining of the wet mass data in step (a) comprises computing, by the controller, an inferred wet mass based on load metadata.

4. The method as defined in claim 1, further comprising measuring, at a process moisture sensor, an amount of moisture removed from the dryer through a dryer exhaust, and the method further comprising calculating, at the controller, a mass of water being removed during the drying of the load in the dryer based on the measured amount of moisture.

5. The method as defined in claim 1, further comprising measuring, at a moisture sensor arranged at an outfeed conveyor system, a moisture content of the dried load, and the method further comprising determining, at the controller, a sheet-level moisture content and therefrom classifying the dried load into predefined moisture bands.

6. The method as defined in claim 1, wherein the determining of the predicted amount of energy in step (c) comprises performing an enthalpy balance calculation across the dryer.

7. The method as defined in claim 1, wherein the determining of the predicted amount of energy in step (c) comprises using a stored dry-density lookup table, or a trained machine-learning model.

8. The method as defined in claim 1, wherein the determining of the at least one operational parameter for the dryer in step (e) comprises using a machine learning system, wherein the controller is configured to predict using the machine learning system, the one or more operational parameters for drying the load of the material to a desired moisture content.

9. The method as defined in claim 1, further comprising:
receiving, from a process moisture sensor arranged in an exhaust of the dryer, in-process data pertaining to a mass of water removed thermally from the load during the drying step;
receiving, from a downstream moisture sensor, final moisture classification data of the dried load; and
performing a closed-loop reconciliation by comparing a predicted value derived from the wet mass data against the received in-process data and the final moisture classification data, and in response, updating an internal predictive model of the controller.

10. The method as defined in claim 9, further comprising re-determining, during the drying of the load, the at least one operational parameter based on the in-process data, and adjusting the operation of the dryer in response.

11. The method as defined in claim 1, wherein the at least one operational parameter is selected from the group consisting of a conveyor speed, a zone temperature, a circulation fan speed, and an exhaust flow rate.

12. The method as defined in claim 1, wherein the dryer comprises a plurality of longitudinal zones, the method further comprising applying the at least one operational parameter as a zone-specific setpoint to one or more of the plurality of zones based on the wet mass data.

13. The method as defined in claim 1, further comprising:
receiving, at the controller, a signal from one or more fire-detection inputs indicating a fire or pre-fire condition; and
in response, automatically activating a fire suppression unit arranged within the dryer as a first automatic control action.

14. The method as defined in claim 1, further comprising:
receiving, from a process moisture sensor and a downstream moisture sensor, data for performing a closed-loop reconciliation; and
updating an internal predictive model of the controller based on an analysis of discrepancies between a predicted value derived from the wet mass data and the data received from the process and downstream moisture sensors.

15. The method as defined in claim 14, wherein the internal predictive model comprises one or more of a stored dry-density lookup table, a set of enthalpy-balance coefficients, and a trained machine-learning model.

16. The method as defined in claim 4, wherein the process moisture sensor comprises an absolute-humidity sensor, and wherein calculating the mass of water being removed comprises multiplying an absolute-humidity value from the sensor by a measured exhaust volumetric flow rate.

17. The method as defined in claim 5, wherein the moisture sensor comprises a brush-conductance-type dry-chain moisture meter, and wherein determining the sheet-level moisture content comprises measuring an alternating current flow between a plurality of wire-brush electrodes contacting a surface of the dried load.

18. The method as defined in claim 1, wherein determining the excess moisture content in step (b) comprises:
calculating an oven-dry mass of the load by multiplying a known dimensional volume of the load by the stored species-specific dry density;
calculating a target mass of the dried load based on the oven-dry mass and a desired final moisture content; and
subtracting the target mass from the determined wet mass data.

19. The method as defined in claim 3, wherein the load metadata is received from one of a user input or a green-stacker control system.

20. The method as defined in claim 1, wherein the load of the material comprises wood veneer.
